(19) United States
(12) Patent Application Publication
(10) Pub. No.: US 2016/0148207 A1
(43) Pub. Date: May 26, 2016

(54) System and Method for a Sustainable Unlimited Return Policy

(71) Applicant: Derrick Tobias Babb, Miami, FL (US)

(72) Inventor: Derrick Tobias Babb, Miami, FL (US)

(21) Appl. No.: 14/879,077

(22) Filed: Oct. 8, 2015

Related U.S. Application Data
(63) Continuation of application No. 62/122,069, filed on Oct. 9, 2014.

(51) Int. Cl. G06Q 20/40; G06Q 30/02

(52) U.S. Cl. CPC G06Q 20/407; G06Q 30/0283

(57) ABSTRACT

Claimed is an extension of an online consignment store model that compensates sellers in store credit or other non-monetary instrument; recovers overhead costs using a mixed cash\store credit sale pricing scheme and/or only accepts items for disposition that were originally sold new by the vendor—or a group of associated vendors; and applies any and/or all plausible means of recovering the maximum compensation for the disposition of the good on behalf of the consumer. This effectively creates a sustainable, optimized and unlimited return policy for goods that will ideally serve as a competitive advantage for the vendor in the marketplace while simultaneously offering consumers the best possible value for their purchase.

### CROSS-REFERENCE TO RELATED APPLICATIONS

This application claims priority to provisional application No. 62/12,2069, filed Oct. 9, 2014.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention is a methodology for a vendor to offer a customer a return policy for a used good that seeks to sustainably maximize value for the customer. This methodology must account for the overhead involved in returns, and overcomes this obstacle with the introduction of a novel pricing scheme. The methodology leverages this scheme in combination with an extension of a consignment store business model. The extension engenders a captured market for the sale of new and used goods. Sustainability is achieved through the combined mitigation of overhead incurred processing returns while contemporaneously evolving a captured-market for the sale of new and used goods.

Consignment shops provide customers with a place to display and sell their merchandise. The shop will decide what they are willing to sell and for what price. After the sell has been completed, the consignment shop and the owner split the profits. If an item does not sell after a certain period of time, the owner has the ability to retrieve the items from the consignment shop. (“What is consignment shop?,” n.d.) An online consignment store is a straightforward extension of this idea, allowing the deposited good to be exhibited online. An online consignment store can be differentiated from an online auction site, in that the item is physically received by the vendor.

A consignment store may only pay out in store credit. (“Would you sell, or consign, your items if they only paid in store credit?,” n.d.) There is at least one reference to a consignment store that only pays out in store credit for children clothes in a certain age.(“Lillie's Closet,” n.d.).

It is commonplace for a retail operation to sell merchandise and allow returns. Examples are Backcountry.com and Recreational Equipment, Inc., which have provided liberal return policies that allowed customers to return used merchandise for a full cash refund at any point in the future. However the idea of buying, using and returning merchandise was never promoted by these organizations. More generally, for stores with such liberal return policies, in today's culture this is considered an abusive practice referred to as “wardrobing.” (“Wardrobing,” 2015)

Bed, Bath and Beyond is another organization promoting an unlimited return policy. Virtually any purchase can be returned for a full cash refund using a receipt. However, if all customers returned all purchases at once, one can reasonably surmise that bankruptcy would quickly ensue. Therefore while this policy offers a competitive advantage in the marketplace over other retailers, it is unsustainable in the extreme. Furthermore, Bed, Bath and Beyond does not explicitly market the idea of buying, using and returning their merchandise. If such an option existed, it might be perceived as having greater value than a conventional unlimited return policy, because it addresses the anxiety people might feel for returning merchandise they legitimately planned to keep.

The primary embodiment of the invention attempts to maximize the compensation to the consumer for a returned good in a buy, use, and return transaction. The overhead for acting on behalf of the consumer to dispose of the good must be recovered in order to sustain the business. Two ways to recover this overhead is to price the new goods so that the overhead for all subsequent overhead from multiple buy, use, and return transactions spanning multiple customers is included. This method disproportionally impacts the buyer of the new good. A more equitable method is to incorporate the cost of the overhead into the resale price of the good. Because consumers may be using store credit for purchases, and transactions for a good can continue ad infimum, it becomes necessary to offer the good for resale using a mixed cash\store credit price. The cash component of the resale price can be used to ensure that overhead is covered without needing to forecast the estimated number of buy, use, and return transactions expected over the course of the useable lifetime of a good and disproportionally impact the initial buyer of the good. There are no known examples of this method in practice. Certainly goods can be purchased with a mix of cash and store credit, but nowhere could an example of systematically imposing that a percentage of a sale price be paid in cash when used in conjunction with store credit be found.

Non-profit organizations offer tax deductions for donations, but do not necessarily act to maximize the value passed back to the consumer for their donation. They might also use various techniques for the disposition of the donated good, but the compensation to the consumer is not based on the actual disposition of the good.

In order for the objective of maximizing value for the customer to be met, a good would need to be disposed of in a manner that passes the largest percentage of compensation back to the consumer. Any intermediary involved in this disposition would have to execute their role at or below cost in order to maximize the percentage of compensation returned back to the consumer. Unless the execution of the intermediary role supports another source of profit, the intermediary has no incentive to provide this service, and thus the service would likely not exist. Therefore we can narrow the scope of this discussion to business processes that handle the disposition of the good at or below cost on behalf of the customer, while attempting to maximize the compensation from this disposition, and that render profit from some other source that is supported by this activity.

Auction sites such as Ebay are readily eliminated, as they derive the bulk of their income from a percentage of income received from an auction by the consumer. Furthermore, online auction sites are distinctively different from online consignment sites, which physically handle the goods being sold. It does not eliminate online retail sites such as Amazon, who could act as no cost intermediary as a means of augmenting their service offering to attract more customers to purchase new goods. However, a site such Amazon acts as a broker accepting used goods sold new by Amazon as well as other retailers. At this point we can distinguish between “open loop” and “closed loop” systems.

An open loop system is defined as a vendor that accepts goods from consumers previously purchased new from the vendor as well as another vendor. A closed loop system is defined as a vendor who accepts used goods from consumers that were previously purchased new from the vendor only.

An online retailer such as Amazon may operate in a manner that maximizes value for the consumer by brokering used goods at cost and passing the largest percentage of compensation back to the consumer. However, Amazon is an embodiment of an open loop system, accepting goods that were originally sold new by other vendors. A retailer that maximizes value for the customer and is an embodiment of a closed loop system would be one that acts as intermediary at cost for the resale of a good previously sold to a consumer and passes the largest percentage of compensation back to the consumer while not accepting goods for resale that were originally sold by another vendor.

If the purpose of acting as an intermediary is to support another source of income, where not acting is disadvantageous, it would be advantageous to increase the volume of available used goods. This would likely preclude disallowing goods sold by other vendors. Therefore, there is no obvious advantage for a retailer seeking to maximize value for the customer to adopt a closed-loop system. This reasoning supports the lack of such a model in practice.

The closed loop system allows this model to be effectively applied as a return policy for an individual vendor or group of vendors. This may not have been considered previously, because vendors are focused on basic transactions not the extended buy, use, and return transaction. For those vendors that do have this focus, it is unlikely that they compensate the consumers based on the actual disposition of the good versus the estimated disposition—such as you would expect from a used car lot. It is unlikely that they compensate in store credit and use a mixed cash\store credit sale prices. Finally, this methodology enables the vendor to manage the lifecycle of a new product from its original sale to its final disposition. This is an unexpected results that can be used to create additional value as well. Two immediate results are the ability to apply best practices in the maintenance of goods spanning multiple consumers in order to optimize the useable life of the good, and to apply best practices in the final disposition of the good that minimizes environmental impact.

If a sustainable method for limitless returns of used products could be established, it would benefit any customer who wishes to liquidate a product for any reason. Customer service is a key differentiator for online retailers. If a method could be devised that made limitless returns sustainable, any retailer using this method would likely be able to sustain a competitive advantage against those who do not in the marketplace.

(Woolston, 1996) presents a methodology for establishing an electronic market for consigned goods. The methodology is focused on enabling speculation of purchased goods.

(Siegel, 2013) presents a rules-based process for handling returns.

(Azzouz, Salapatek, & Buiteweg, 2013) address remanufacturing recoverable goods based upon available inventory from providers. Rules-based decision making is used to drive which goods are processed from available inventory.

### BRIEF DESCRIPTION OF INVENTION

Claimed is an extension of an online consignment store model that compensates sellers in store credit or other non-monetary instrument; recovers overhead costs using a mixed cash\store credit sale pricing scheme and/or only accepts items for disposition that were originally sold new by the vendor—or a group of associated vendors; and applies any and/or all plausible means of recovering the maximum compensation for the disposition of the good on behalf of the consumer. This effectively creates a sustainable, optimized and unlimited return policy for goods that will ideally serve as a competitive advantage for the vendor in the marketplace while simultaneously offering consumers the best possible value for their purchase.

### BRIEF DESCRIPTION OF THE DRAWINGS

FIG. 1 embodies the invented process.

FIG. 2 depicts a Dutch auction used to resell products.

### DETAILED DESCRIPTION

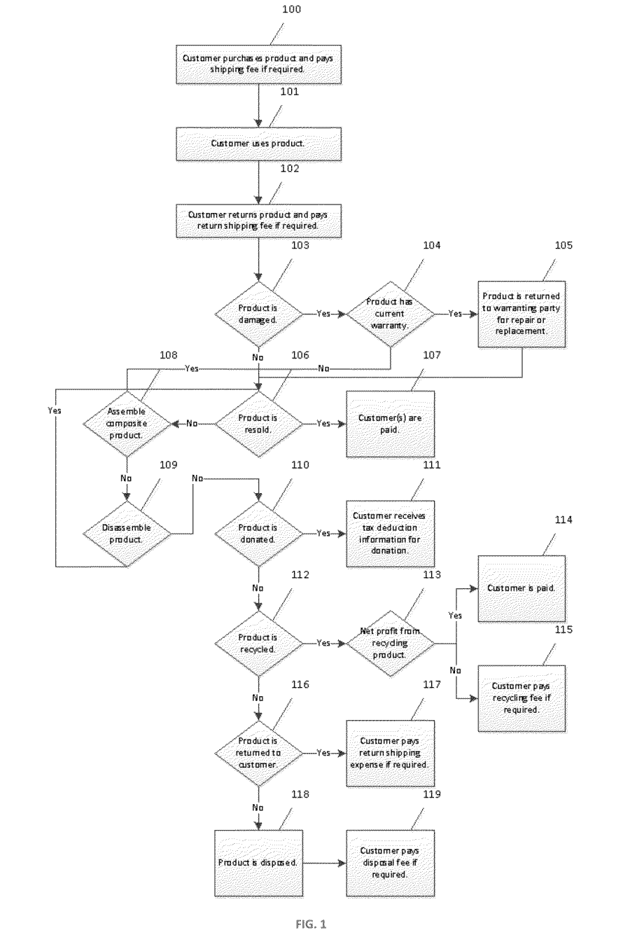

With reference to FIG. 1, the process begins with the sale of a product to a customer in step 100, the usage of this product by the customer in step 101, and the eventual return of the product by the customer in step 102.

In the embodiment of the invention, either the product is priced using a combination of cash and store credit; and/or the product is new or was previously sold new by the vendor creating a closed loop.

In step 103, the product is evaluated for damage. If the product is determined to be damaged, in step 104 it is determined if the product has a current warranty. If the product has a current warranty, it is returned to the warrantying party for repair or replacement in step 105.

In step 106, an attempt is made to resell the product. If the product is resold, the customer is paid in step 107.

In step 108, a decision is made whether or not to assemble the product into a composite product using other products, potentially from other customers. If a composite product is assembled, then step 106 is repeated for the composite product.

In step 109, a decision is made whether or not to dissemble the product into multiple products. If the product is disassembled, then step 106 may be repeated and/or step 110 may be executed for the each of the resulting products.

In step 110, a decision is made whether or not to donate the product. If the product is donated, then the tax deduction information for donation is provided to the customer in step 111.

In step 112, a decision is made whether or not to recycle the product. If the product is recycled and there is a net profit in step 113, the customer is paid in step 114. If the product is recycled and there is not a net profit in step 113, the customer may be required to pay a recycling fee in step 115.

In step 116, a decision is made whether or not to return the product to the customer. If the product is returned, the customer may be required to pay the return shipping expense in step 117.

In step 118, a product is to be disposed. The customer may be required to pay a disposal fee in step 119.

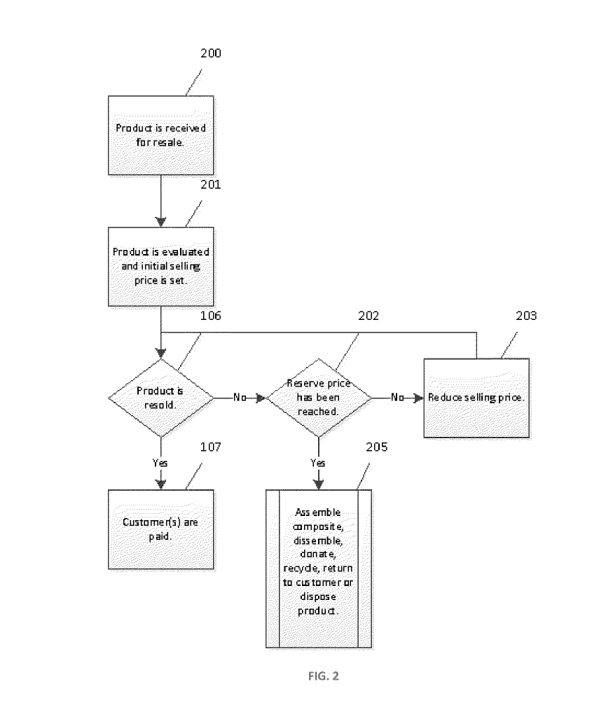

With reference to FIG. 2, a Dutch auction is used to drive the resell of the product. Preceding step 106, the product is received for resale in step 200. The product is evaluated and an initial selling price for the Dutch auction is set in step 201. If the product is not resold in step 106 in a predetermined time period and the reserve price has not been reached in step 202, the selling price is reduced in step 203 and another attempt to resell the product is made. These steps repeat until the product is resold in step 106 or the reserve price is reached in step 202. If the product is unsold in step 106 and the reserve price has been reached in step 202, then the product is assembled into a composite product, dissembled, donated, recycled, returned to the customer and/or disposed in step 205. If the product is sold, the customer is paid in step 107.

In the embodiment of the invention, the customer is compensated based on the actual disposition of the good and the compensation is in the form of a store credit or other non-monetary instrument such as a tax deduction.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

The invention is claimed:

1. A process comprising:
the pricing of a good by a vendor that is a combination of cash and store credit available with the vendor; where
cash can be used in-place of store credit,
and store credit cannot be used in place of cash.

2. Claim 1 having a minimal cash component.

3. Claim 1 having a maximal store credit component.

4. Claim 1 wherein the cash component is based on the overhead involved in handling of the return and disposition of the good.

5. Claim 4 wherein the cash component is a flat rate.

6. Claim 4 where in the cash component is an estimate.

7. Claim 6 wherein the estimate is based on the average of previous overhead for handling a particular good or class of goods.

8. Claim 7 wherein the current condition of the good is a factor in the estimate.

9. Claim 1 extended to an association of vendors and/or third-party.

10. A process comprising:
the provisioning of a good to a customer by a vendor;
the use of the good by the customer;
the return of the used good by the customer to the vendor;
the disposition of the used good by the vendor;
the compensating of the customer; where
the compensation to the customer is based on the actual disposition of the good; and
the compensation is in the form of a store credit;
the good is priced using the scheme define in claim 1 and/or the good is unused or used and previously sold by the vendor.

11. Claim 10 where compensation to the customer is based on the estimated disposition of the good.

12. Claim 10 where the compensation to the customer is equal in amount to the value recovered in the disposition of the good.

13. Claim 10 where compensation is in the form of cash or cash is a component of the compensation.

14. Claim 10 where compensation is in the form of non-monetary instrument.

15. Claim 14 where compensation is in the form of itemized tax deductions.

16. Claim 10 where the disposition of the good is handled by an expert system that takes as inputs the condition of the returned item and information on available methods of disposition, then provides as output a decision for which method of disposition should be utilized.

17. Claim 16 where the handling of the good is automated and directed based upon the output of the expert system.
